(19) United States
(12) Patent Application Publication
(10) Pub. No.: US 2024/0114884 A1
(43) Pub. Date: Apr. 11, 2024

(54) SQUID LURE FOR FISHING

(71) Applicant: Nomad Tackle Pty Ltd, Alderley (AU)

(72) Inventor: Damon Andrew OLSEN, Queensland (AU)

(21) Appl. No.: 18/190,877

(22) Filed: Mar. 27, 2023

(30) Foreign Application Priority Data
Oct. 7, 2022 (AU) 2022902937

(51) Int. Cl. A01K 85/16; A01K 85/00

(52) U.S. Cl. CPC A01K 85/16; A01K 85/1821

(57) ABSTRACT

A bibless squid lure having a body, the body comprising a rigid head and one or more flexible tentacles attached to the head; the head having a ventral side and a dorsal side with a tow point attached to the ventral side and a hook adapter attached to the dorsal side; the head having a weight located in the dorsal portion; wherein the head and the tentacles are shaped so that, when the lure is pulled through water, the body vibrates. The weight may be located towards a front of the head and primarily located in the ventral portion. The head may comprise a flat dorsal region having little or no lateral curvature.

### PRIORITY

This application is related to and claims the priority benefit of Australian Patent Application No. 2022902937 filed Oct. 7, 2022. The content of the aforementioned application is hereby incorporated by reference in its entirety into this disclosure.

### TECHNICAL FIELD

Embodiments relate to a squid lure for fishing and, in particular, lures for fishing shaped to resemble a squid.

### BACKGROUND

Lures used to entice fish come in many different forms. Many lures are intended to imitate bait. Where the bait is other fish, the lures may be shaped and coloured to imitate the creatures the intended catch fish prey upon.

However, it has been found that the effectiveness of such lures can be significantly improved if they imitate the behaviour of the bait. One of the ways in which that behaviour can be imitated is by simulating the swimming motion of the bait fish or other marine animal.

Such a simulated swimming motion generally comprises imparting an oscillation to the body of the lure when the lure moves through the water. Such an oscillation mimics the swimming motion of fish and other aquatic animals and the perception is that the lure will then appear more life-like and therefore be more effective at catching fish.

Oscillation of the lure body as the lure moves through the water can take two forms. As used herein the term “vibration” refers to a repetitive oscillation primarily about a longitudinal axis of the lure, discernible by the naked eye. The movement imparted to a lure which “vibrates” is different from, and more pronounced than, the random movement of an object sinking or moving through water which, due to the chaotic nature of the turbulence of the water passing over the object, may cause the object to display some relative body movement. The term “vibrates” generally refers to a lure with a towpoint on the top part of the body and the vibration is achieved when lifted upwards and/or forwards through water.

The term “wiggle”, on the other hand, refers to an oscillation primarily about a vertical axis which is generally perpendicular to the longitudinal axis. Typically, a lure which wiggles will have the head and tail of the lure move in opposite directions relative to a vertical axis.

Somewhat confusingly, the term “wiggle” may also, in some instances in the art, be referred to as “swimming”. However, this terminology will be avoided here as the vibration is also a simulation of a swimming motion.

### SUMMARY

An embodiment provides for a squid lure having a body, the body comprising a rigid head and one or more flexible tentacles attached to the head; the head having a ventral side and a dorsal side with a tow point attached to the ventral side and a hook adapter attached to the dorsal side; the head having a weight located in the dorsal portion; wherein the head and the tentacles are shaped so that, when the lure is pulled through water, the body vibrates.

The weight may be located towards a front of the head. The front of the head may be the region of the head leading in usual motion of the squid which the lure is intended to imitate.

Although a portion of the weight may extend into the dorsal portion of the body, the weight may be primarily located in the ventral portion.

The head may comprise a flat dorsal region. The flat dorsal region may have little or no lateral curvature. The flat dorsal region may follow the longitudinal curvature of the head.

The lure may lack a bib or lip. The lure may be a casting lure. The only deviation in a shape of the body from that of a squid may be hook and line attachments such as loops, the tow point and the hook adaptor.

Although a lure without a bib (or bibless lure) is intended primarily for casting it is to be understood that such lures find application elsewhere such as in kite fishing or slow-speed trawling.

The head may comprise a mantle portion and a mid-portion with the mid-portion located between the mantle and the one or more tentacles. The mid-portion may comprise two eye cavities. The eye cavities may describe a concave shape and may be located on opposite sides of the mid-portion.

Previously lures imitating the shape of a squid have not shown effective swimming motion. The swimming motion of lures is a highly complex dynamic system and is therefore not readily understood by analysis. An existing supposition is that such lures, compared to lures which are shaped to imitate fish bait, require additional vibration to counteract a dampening effect of the tentacles. Furthermore, many existing fish-shaped lures allow body profiles (for example lateral concave portions) which help to impart a vibration which may be incompatible with a squid-like appearance.

Due to the chaotic nature of the movement of the lure, it is not possible to exhaustively investigate each of the factors which may contribute to achieving a sufficiently pronounced vibration to overcome the dampening effect of the tentacles. However, it has been noted in certain embodiments that the lead weight, the flat dorsal region and the tow point may act together to significantly accentuate the vibration motion of the lure. In an embodiment, if the weight is located primarily in the ventral portion this may assist in positioning the flat dorsal region relative to the flow of water around the lure so that the flat dorsal region creates sufficient turbulence to impart a vibration to the lure. Furthermore, since the direction of the lure through the water may at least partially be influenced by the location of the tow point, in certain embodiments, the location of the tow point may contribute to the vibration of the lure.

It has been found for certain embodiments, the ratios of certain body dimensions may accentuate the vibration motion. All dimensions may exclude the hook and line attachments such as loops, the tow point and the hook adaptor. Furthermore, when considering such dimensions, the flexible portions of the lure such as the tentacles are extended outwards without bending.

The lure may have a head length (B) and a maximum head thickness (C). The tow point may comprise a loop. The tow point may be located at a tow point distance (A) from a tip of the head. The tow point distance may be measured along a length of the lure. The tow point distance may be measured from a tip of the head to the portion of the loop on a surface of the head.

A ratio of the tow point distance (A) to the head length (B) may be between 0.55 and 0.25. In an embodiment, the ratio of the tow point distance to the body length is about 0.5.

The head may have a maximum height (D). A height of the head may be measured from the ventral side to the dorsal side. A ratio of the maximum head thickness (C) to the maximum head height (D) may be between 0.35 to 0.55. In an embodiment, the ratio of the maximum head thickness (C) to the maximum head height (D) is about 0.5.

An eye thickness of the head may be a cross-sectional distance measured between respective lowest points of the concave eye cavities. A ratio of the eye thickness (F) to the maximum head thickness (C) may be 0.85 to 1. In an embodiment, the ratio of the eye thickness to the maximum body thickness may be about 0.9. The lowest point of the concave eye cavity may be the shallowest point. In an embodiment where the eyes are not defined by cavities, the eye thickness may be taken at a position corresponding to a centre of the eye.

The lure may have an overall length (H) measured from a tip of the head to a tip of a longest tentacle, when extended in a direction along a length of the lure. A ratio of the head length (B) to the overall length (H) may between 0.4 to 0.6. In an embodiment, the ratio of the head length (B) to the overall length (H) is about 0.5.

The one or more tentacles may define a tentacle shoulder wherein the body has a tentacle shoulder thickness (E) at the tentacle shoulder. A ratio of the maximum head thickness (C) to the shoulder thickness (E) may be 1.1 to 1.4, preferably about 1.25.

The one or more tentacles may comprise at least one longer tentacle and at least one shorter tentacle, designed to replicate the tentacle structure of a squid. The at least one longer tentacle may have a longer tentacle distance (G) and the at least one short tentacle may have a shorter tentacle distance. A ratio of the head length added to the shorter tentacle distance (J) to the head length (B) may be 0.55 to 0.75, preferably about 0.65.

The flat dorsal region may have a maximum thickness (I). A ratio of the maximum thickness of the flat dorsal region (I) to the maximum head thickness (C) may be between 0.55 and 0.7, preferably about 0.625. A ratio of the maximum thickness of the flat dorsal region (I) to the maximum head height (D) may be between 0.23 to 0.35, preferably about 0.29.

The hook adapter may be located a distance from the tip of the head. The distance from the tip of the head to the hook adaptor measured along a length of the lure may be less than the tow point distance (A). Where there is more than one hook adaptor, the distance from the tip of the head to the foremost hook adaptor measured along a length of the lure may be less than the tow point distance (A).

### BRIEF DESCRIPTION OF THE FIGURES

Embodiments are herein described, with reference to the accompanying drawings in which:

FIG. 1 is a side view of a squid lure for fishing according to an embodiment;

FIG. 2 is a cross-section through the lime A-A of FIG. 1;

FIG. 3 is a top view of the lure of FIG. 1; and

FIG. 4 is a right side view of the lure of FIG. 1.

### DETAILED DESCRIPTION

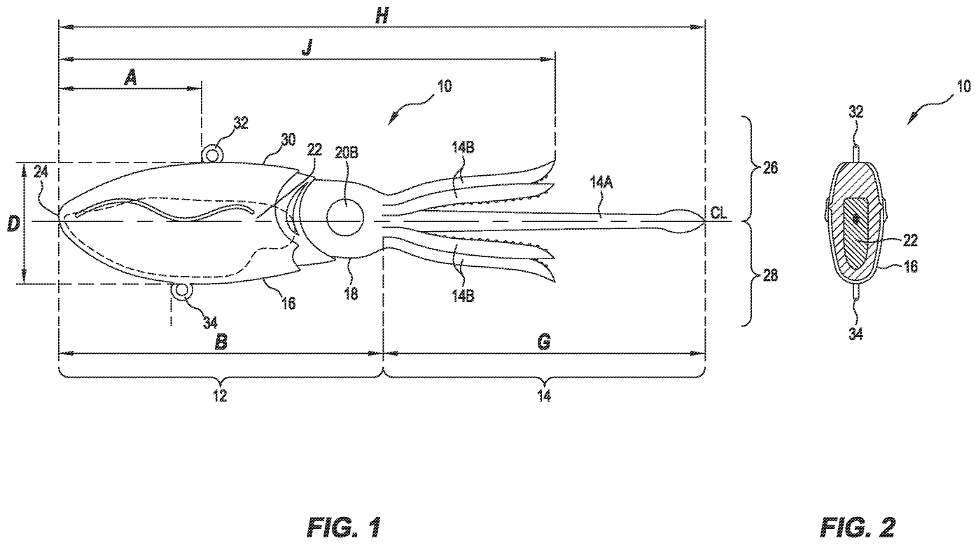

FIG. 1 illustrates a lure for fishing 10 according to an embodiment. The lure 10 illustrated in FIG. 1 is representative of embodiments of the invention since the simulated swimming motion may be achieved with lures of different sizes, scaled accordingly. Therefore, the dimensions of the lure are discussed below in relative terms, and some specific dimensions are set out by way of example. However, it is to be realised that many variations are possible, within the constraints discussed above, and below.

The lure 10 is formed with a head 12 attached to tentacles 14. As illustrated, there are two longer tentacles 14A and four shorter tentacles 14B. It is to be realised that in further embodiments, all the tentacles may have the same length, and the number of tentacles of each type may vary.

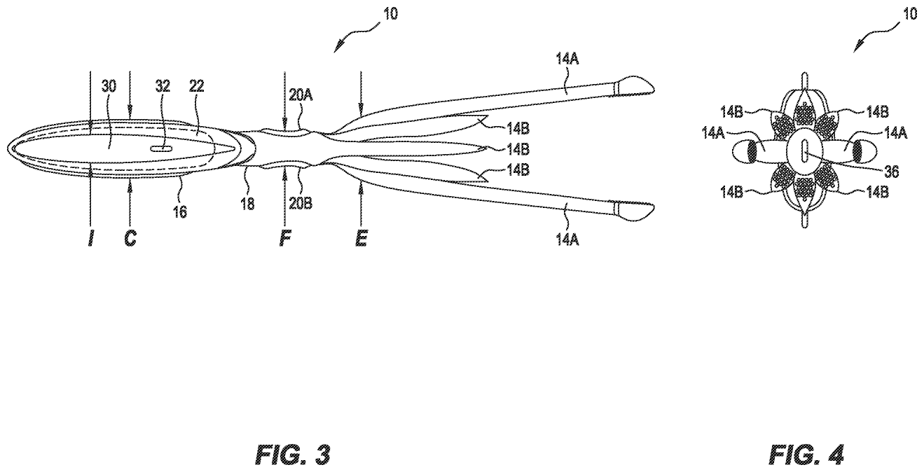

The head 12 includes a mantle 16 attached to a mid-portion 18. The tentacles 14 are attached to the mid-portion 18. Two eye cavities 20A and 20B are formed on opposite sides of the mid portion 18. As best illustrated in FIG. 3, each eye cavity 20A, 20B is formed by a concave void in the sides of the mid-portion 18.

The head 12 has a tip 24 which designates a front of the lure 10. A centre line (CL) is shown in FIG. 1 joining the tip, mid-way through the mid-portion and mid-way through the longer tentacle 14A (which is situated on the middle of the lateral side of the lure 10 visible in FIG. 1), to the end of the longer tentacle 14A. The centre line (CL) divides the lure into a dorsal side 26 and a ventral side 28.

A weight 22 is provided embed in the mantle 16. The weight is situated primarily in the ventral side 28. In this embodiment, the majority of the weight is located in the ventral side 28. Furthermore, the weight is located toward the tip, and away from the mid-portion 18. In this embodiment, the weight is constructed from lead, but any relatively dense material may be used instead.

The dorsal side 26 has a flat upper surface (with reference to the orientation of FIG. 1), the flat dorsal region 30. The flat dorsal region 30 is shown in FIG. 3, but as illustrated in FIG. 1, the flat dorsal region 30 is flat laterally, but not longitudinally. In the longitudinal direction of the lure 10, the flat dorsal region 30 follows the longitudinal curvature of the head 12.

A tow point in the form an eyelet 32 is provided on the dorsal side, 26, located on the flat dorsal region 30. A hook adaptor, also in the form of an eyelet 34 is provided on the ventral side 28. A further hook adapter, eyelet 36, is provided at a rear of the mid-portion 18. Although the hook and tow adaptors are here provided as eyelets, many other forms of attachment are possible instead of, or in addition to, eyelets.

The tow point eyelet 32 may be used to attach the lure to a line used with a rod or kite, or to a tow line when the lure is to be towed behind a vehicle.

The following dimensions are indicated in the accompanying Figures. In certain embodiments, these dimensions exclude the hook and tow adaptors such as eyelets 32, 34 and 36. Where the tentacles are included in the dimensions, the tentacles are arranged as illustrated—orientated substantially along the length of the lure 10 and at rest (i.e. without any artificial bend induced into the material comprising the tentacles). Furthermore, all dimensions are measured in a linear manner, either along the length of the lure 10 (i.e. parallel to the centre line CL) or in a direction perpendicular thereto. Unless otherwise indicated, dimensions do not take the curvature of the lure into account.
(A) Tow point distance. This is the distance from the tip 24 to the foremost attachment point of the eyelet 32 to the dorsal side 30.
(B) Head length. The distance from the tip 24 to the back of the mid-portion 18.
(C) Maximum head thickness. The maximum thickness of the head 12 measured from side to side (FIG. 3).
(D) Maximum head height. The maximum height of the head measured from the top of the dorsal side 26 to the bottom of the ventral side 28 (FIG. 1). The length, thickness and height are measured in directions orthogonal to one another.
(E) Tentacle shoulder thickness. The thickness of the lure measured at the tentacle shoulder.
(F) Eye thickness. The thickness of the mid-portion measured between the deepest points of the concave cavities forming the eyes 20A and 20B. Alternatively, if the eyes are not concave, the thickness of the mid-portion measured between central portions of the eves.
(G) Longer tentacle distance. The length of the longer tentacles 14A. Alternatively, the length of the longest tentacles.
(H) Overall length. The length of the lure 10 from the tip 24 to the end of the long tentacle 14A.
(I) A maximum thickness of the flat dorsal region 30.
(J) Combination of the head length (B) and the length of the shorter tentacle 14B.

In certain embodiments it has been found that the following ranges for these ratios of the aforementioned dimensions may provide a pronounced vibration:

| | |
|---|---|
| A:B | 0.55 to 0.25 |
| C:D | 0.35 to 0.55 |
| F:C | 0.85 to 1 |
| B:H | 0.4 to 0.6 |
| C:E | 1.1 to 1.4 |
| J:B | 0.55 to 0.75 |
| I:C | 0.55 and 0.7 |
| I:D | 0.23 to 0.35 |

The distance from the tip of the head to the hook adaptor eyelet 34 is less than the distance from the tip of the head to the tow point eyelet 32 (A).

The upper and lower parts of the body rotate around the A-A axis making an angle of up to degrees off the centre line CL. In a certain embodiment, the vibration of the lure comprising repetitive oscillation about the longitudinal axis of the lure (A-A) may describe deviations of up to degrees from the vertical. However, in other embodiments the deviation from the vertical may be less pronounced. In an embodiment, this deviation is about 30 degrees, or less. Other variations in the angle are also possible. Furthermore, it is to be realised that the behaviour depends on turbulence in the water and other chaotic factors, so these values are averages.

In certain embodiments the lure does not comprise a bib or lip (referred to herein as a “bibless squid lure”) and the shape of the lure (other than the tow point and hook adaptors) resembles the general shape of a squid. Therefore, the primary use of the lure is for casting using a fishing rod. However, it is to be realised that other uses such as kite fishing or trolling are not excluded, but may be significantly less effective.

In certain embodiments, the provision of the weight located primarily in the ventral region, the flat dorsal region and the location of the tow point may be primary factors influencing the ability of the lure to vibrate, provided that the lure resembles the shape of a squid with associated squid like tentacles. In an embodiment, the tow point is located behind the thickest part of the flat head (I).

It is to be realised that a number of embodiments are possible with the constraints discussed herein. Without limitation, the following are examples of measurements of the dimensions in the accompanying Figures, for four different lure sizes (identified as “9.5”, “11”, “13”, and “15”).

| Lure | A | B | C | D | E | F | G | H | I | J |
|---|---|---|---|---|---|---|---|---|---|---|
| 9.5 | 28.5 | 63 | 10.80 | 22.80 | 11.80 | 7.20 | 55.80 | 120 | 5.50 | 93.30 |
| 11 | 33 | 72 | 13.10 | 26.30 | 14.10 | 9 | 64.50 | 138.20 | 6.90 | 110 |
| 13 | 40 | 89 | 16.10 | 32.10 | 15 | 9.90 | 78.80 | 174 | 8.10 | 133.30 |
| 15 | 47.10 | 100 | 17.50 | 36.80 | 17.80 | 12.50 | 92 | 197 | 9.60 | 150.90 |

It is to be understood that, if any prior art publication is referred to herein, such reference does not constitute an admission that the publication forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments. Similarly, the word “device” is used in a broad sense and is intended to cover the constituent parts provided as an integral whole as well as an instantiation where one or more of the constituent parts are provided separate to one another.

### FIGURE REFERENCE NUMBERS

10 Lure
12 Head
14 Tentacle Region
14A Long Tentacles
14B Short Tentacles
16 Mantle
18 Mid-portion
20A, B Eye cavity
22 Weight
24 Tip
26 Dorsal side
28 Ventral side
30 Flat dorsal region
32 Tow eyelet
34 Hook adaptor
36 Rear hook adaptor

1. A bibless squid lure having a body, the body comprising a rigid head and one or more flexible tentacles attached to the head; the head having a ventral side and a dorsal side with a tow point attached to the ventral side and a hook adapter attached to the dorsal side; the head having a weight located in a dorsal portion; wherein the head and the tentacles are shaped so that, when the lure is lifted upwards or pulled forwards through water, the body vibrates in a repetitive oscillation primarily about a longitudinal axis of the body relative to a reference frame moving with the body.

2. The bibless squid lure according to claim 1 wherein the weight is located towards a front of the head.

3. The bibless squid lure according to claim 1, wherein the weight is primarily located in a ventral portion.

4. The bibless squid lure according to claim 1, wherein the head has a generally oval cross-section along a substantial portion of a length of the head and wherein the portion of the head having the generally oval cross section comprises a dorsal region having little or no lateral curvature.

5. The bibless squid lure according to claim 1, wherein the head comprises a mantle portion and a mid-portion with the mid-portion located between the mantle and the one or more flexible tentacles.

6. The bibless squid lure according to claim 5 wherein the mid-portion comprises two eye cavities, the eye cavities describing a concave shape and located on opposite sides of the mid-portion.

7. The bibless squid lure according to claim 1, having a head length (B) and a maximum head thickness (C), wherein the tow point is located at a tow point distance (A) from a tip of the head and wherein a ratio of the tow point distance (A) to the head length (B) is between 0.55 and 0.25.

8. The bibless squid lure according to claim 7 wherein the head has a maximum height (D) and wherein a ratio of the maximum head thickness (C) to the maximum head height (D) is between 0.35 and 0.55.

9. The bibless squid lure according to claim 8 wherein an eye thickness of the head is a cross-sectional distance measured between respective lowest points of the concave eye cavities and wherein a ratio of the eye thickness (F) to the maximum head thickness (C) is between 0.85 and 1.

10. The bibless squid lure according to claim 7, where the lure has an overall length (H) measured from a tip of the head to a tip of a longest tentacle when extended in a direction along a length of the lure and wherein a ratio of the head length (B) to the overall length (H) is between 0.4 and 0.6.

11. The bibless squid lure according to claim 7, wherein the one or more flexible tentacles define a tentacle shoulder wherein the body has a tentacle shoulder thickness (E) at the tentacle shoulder, and wherein a ratio of the maximum head thickness (C) to the shoulder thickness (E) is 1.1 to 1.4.

12. The bibless squid lure according to claim 1, wherein the one or more flexible tentacles comprises at least one longer tentacle and at least one shorter tentacle, the at least one longer tentacle having a longer tentacle distance (G) as compared to the at least one shorter tentacle and the at least one shorter tentacle having a shorter tentacle distance as compared to the at least one longer tentacle.

13. The bibless squid lure according to claim 12, having a head length (B) and a maximum head thickness (C), wherein:
the tow point is located at a tow point distance (A) from a tip of the head and wherein a ratio of the tow point distance (A) to the head length (B) is between 0.55 and 0.25; and
a ratio of the head length added to the shorter tentacle distance (J) to the head length (B) is between 0.55 and 0.75.

14. The bibless squid lure according to claim 4, wherein:
the lure has a head length (B) and a maximum head thickness (C), wherein the tow point is located at a tow point distance (A) from a tip of the head and wherein a ratio of the tow point distance (A) to the head length (B) is between 0.55 and 0.25; and
the dorsal region having little or no lateral curvature has a maximum thickness (I) and wherein a ratio of the maximum thickness of the dorsal region having little or no curvature (I) to the maximum head thickness (C) is between 0.55 and 0.7.

15. The bibless squid lure according to claim 14, wherein a ratio of the maximum thickness of the flat region (I) to the maximum head height (D) is between 0.23 to 0.35.

16. The bibless squid lure according to claim 7 wherein the hook adapter is located a distance from the tip of the head and wherein the distance from the tip of the head to the hook adaptor measured along a length of the lure is less than the tow point distance (A).
